(19) United States
(12) Patent Application Publication
(10) Pub. No.: US 2025/0285626 A1
(43) Pub. Date: Sep. 11, 2025

(54) AUDIO TRANSLATION WITH PRESERVED SPEAKER CHARACTERISTICS

(71) Applicant: Roblox Corporation, San Mateo, CA (US)

(72) Inventors: Nameer HIRSCHKIND, San Francisco, CA (US); Kyle Joseph SPENCE, Redwood City, CA (US); Xiao YU, San Mateo, CA (US); Charles SHANG, San Mateo, CA (US)

(73) Assignee: Roblox Corporation, San Mateo, CA (US)

(21) Appl. No.: 19/073,736

(22) Filed: Mar. 7, 2025

Related U.S. Application Data
(60) Provisional application No. 63/563,066, filed on Mar. 8, 2024.
(60) Provisional application No. 63/566,084, filed on Mar. 15, 2024.
(60) Provisional application No. 63/689,055, filed on Aug. 30, 2024.

(51) Int. Cl. G10L 19/00; G10L 13/04

(52) U.S. Cl. CPC G10L 19/0018; G10L 13/04

(57) ABSTRACT

A method includes receiving an audio stream from a first user associated with a first client device, wherein the audio stream is spoken in a first language by the first user. The method further includes retrieving translation data associated with a second user. The method further includes converting a first portion of the audio stream received from the first user into a plurality of phonemes of a second language, wherein the second language is defined by the language preference. The method further includes predicting a respective duration of each of the phonemes in the plurality of phonemes. The method further includes outputting, by a synthesizer, a first portion of output speech that includes the plurality of phonemes where each of the phonemes in the plurality of phonemes has the respective duration. The method further includes providing the first portion of output speech to the second user device.

### CROSS-REFERENCE TO RELATED APPLICATIONS

This application is a non-provisional application that claims priority under 35 U.S.C. § 119(e) to U.S. Provisional Patent Application No. 63/563,066, filed on Mar. 8, 2024; U.S. and titled “Voice Chat Translation”; Provisional Patent Application No. 63/566,084, filed on Mar. 15, 2024 and titled “Voice Chat Translation”; and U.S. Provisional Patent Application No. 63/689,055, filed on Aug. 30, 2024 and titled “Voice Chat Translation,” the contents of each of which are hereby incorporated by reference herein in its entirety.

### TECHNICAL FIELD

Embodiments relate generally to audio translations via a computer device, and more particularly, to methods, systems, and computer-readable media for providing a speech-to-speech translation that retains user voice characteristics.

### BACKGROUND

Computer audio (e.g., chat between users of computer devices) oftentimes consists of monaural or stereo audio being provided as it is received from a listening device or microphone. When audio is to be translated for various users speaking different languages, most solutions rely on text-based translations that provide simple functionality that includes only word-for-word or phrase translations presented in text. Therefore, much of the context and/or emotion associated with a user's audio stream may be lost in translation. In addition, the process of converting audio to text, translating the text, and converting the translated text to translated audio introduces errors and latency that make it difficult to conduct back and forth conversations with people.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method of audio translation includes receiving an audio stream from a first user associated with a first client device, wherein the audio stream is spoken in a first language by the first user. The method further includes retrieving translation data associated with a second user, wherein the translation data includes at least a language preference associated with the second user, and wherein the second user is associated with a second user device. The method further includes converting a first portion of the audio stream received from the first user into a plurality of phonemes of a second language, wherein the second language is defined by the language preference. The method further includes predicting a respective duration of each of the phonemes in the plurality of phonemes. The method further includes outputting, by a synthesizer, a first portion of output speech that includes the plurality of phonemes where each of the phonemes in the plurality of phonemes has the respective duration. The method further includes providing the first portion of output speech to the second user device, where additional portions of the output speech are output based on subsequent portions of the audio stream.

In some embodiments, the method further includes providing the first portion the audio stream as input to a tokenizer, providing output from the tokenizer as input to an encoder, and outputting, with the encoder, a vector representation of the audio stream, wherein the first portion of the audio stream that is converted is the vector representation of the audio stream. In some embodiments, converting the vector representation of the audio stream into the plurality of phonemes includes: outputting, with a phoneme decoder, a first predicted phoneme of the plurality of phonemes; generating a first query from the first predicted phoneme; providing the first query, and a first key and a first value based on the vector representation of the audio stream to the phoneme decoder; outputting, with the phoneme decoder, a subsequent predicted phoneme of the plurality of phonemes; generating a subsequent query from the subsequent predicted phoneme; providing the subsequent query, and a subsequent key and a subsequent value based on the vector representation of the audio stream to the phoneme decoder; and continuing to predict phonemes with the phoneme decoder until a remaining vector representation of the audio stream is processed.

In some embodiments, predicting a duration of each of the phonemes in the plurality of phonemes includes: receiving, at an attention layer and from a phoneme decoder, a plurality of vectors that correspond to the plurality of phonemes; converting, by the attention layer, the plurality of vectors into respective queries; and generating, by the attention layer, output feature vectors based on the plurality of vectors that correspond to the plurality of phonemes and the vector representation of the audio stream. In some embodiments, the method further includes providing the output feature vectors to a variance predictor that predicts a variance of each phoneme of the plurality of phonemes. In some embodiments, the method further includes providing the output feature vectors to a duration predictor, wherein predicting the respective duration of each of the phonemes in the plurality of phonemes is performed using the duration predictor. In some embodiments, the method further includes prior to outputting the first portion of the output speech, performing Gaussian upsampling of the output feature vectors, wherein the Gaussian upsampling is performed to an input rate of the synthesizer.

In some embodiments, wherein outputting the first portion of output speech by the synthesizer includes outputting hidden states corresponding to the plurality of phonemes, and further comprising, before providing the first portion of output speech to the second user device, transforming the hidden states corresponding to the plurality of phonemes into audio using a vocoder. In some embodiments, the audio stream is associated with a voice chat function of a virtual experience. In some embodiments, the synthesizer is trained by training a first synthesizer using a synthesizer loss, replacing the first synthesizer with a diffusion synthesizer, and fine-tuning the diffusion synthesizer.

A trained machine-learning system comprises: an encoder implemented by one or more processors, the encoder trained to perform operations comprising receiving an audio stream spoken in a first language and outputting encoded audio; a phoneme decoder implemented by the one or more processors, the phoneme decoder trained to perform operations comprising receiving the encoded audio from the encoder and converting a first portion of the encoded audio into a plurality of phonemes of a second language; a duration predictor implemented by the one or more processors, the duration predictor including a transformer encoder that is trained to perform operations comprising receiving the plurality of phonemes from the phoneme decoder and predicting a respective duration of respective phonemes in the plurality of phonemes; and a synthesizer implemented by the one or more processors, the synthesizer trained to perform operations comprising outputting the first portion of output speech that includes the plurality of phonemes where each of the phonemes in the plurality of phonemes has the respective duration.

In some embodiments, the machine-learning system is trained by: individually training the phoneme decoder using a decoder cross-entropy loss, the duration predictor using a per-phoneme L2 duration loss, and the synthesizer using a synthesizer loss; and training the phoneme decoder, the duration predictor, and the synthesizer together using an overall loss. In some embodiments, the overall loss is a weighted sum of the decoder loss, the duration loss, and the synthesizer loss. In some embodiments, training the phoneme decoder, the duration predictor, and the synthesizer together includes training on speech to text translation tasks and speech to speech translation tasks. In some embodiments, the encoder and the phoneme decoder are trained using synthetic training data that is generated by: generating text in a style associated with a virtual experience from a chatbot, translating the text to source audio in one or more different languages, and using the text as ground truth data.

A non-transitory computer-readable medium with instructions stored thereon that, when executed by one or more computers, causes the one or more computers to perform operations. The operations include receiving an audio stream from a first user associated with a first client device, wherein the audio stream is spoken in a first language by the first user; retrieving translation data associated with a second user, wherein the translation data includes at least a language preference associated with the second user, and wherein the second user is associated with a second user device; converting a first portion of the audio stream received from the first user into a plurality of phonemes of a second language, wherein the second language is defined by the language preference; predicting a respective duration of each of the phonemes in the plurality of phonemes; outputting, by a synthesizer, a first portion of output speech that includes the plurality of phonemes where each of the phonemes in the plurality of phonemes has the respective duration; and providing the first portion of output speech to the second user device, where additional portions of the output speech are output based on subsequent portions of the audio stream.

In some embodiments, the operations further include: providing the first portion the audio stream as input to a tokenizer; providing output from the tokenizer as input to an encoder; and outputting, with the encoder, a vector representation of the audio stream, wherein the first portion of the audio stream that is converted is the vector representation of the audio stream. In some embodiments, converting the vector representation of the audio stream into the plurality of phonemes includes: outputting, with a phoneme decoder, a first predicted phoneme of the plurality of phonemes; generating a first query from the first predicted phoneme; providing the first query, and a first key and a first value based on the vector representation of the audio stream to the phoneme decoder; outputting, with the phoneme decoder, a subsequent predicted phoneme of the plurality of phonemes; generating a subsequent query from the subsequent predicted phoneme; providing the subsequent query, and a subsequent key and a subsequent value based on the vector representation of the audio stream to the phoneme decoder; and continuing to predict phonemes with the phoneme decoder until a remaining vector representation of the audio stream is processed. In some embodiments, predicting a duration of each of the phonemes in the plurality of phonemes includes: receiving, at an attention layer and from a phoneme decoder, a plurality of vectors that correspond to the plurality of phonemes; converting, by the attention layer, the plurality of vectors into respective queries; and generating, by the attention layer, output feature vectors based on the plurality of vectors that correspond to the plurality of phonemes and the vector representation of the audio stream. In some embodiments, the operations further include providing the output feature vectors to a variance predictor that predicts a variance of each phoneme of the plurality of phonemes.

### BRIEF DESCRIPTION OF THE DRAWINGS

FIG. 1 is a block diagram of an example network environment for providing audio translation, according to some embodiments.

FIG. 2 is a block diagram of an example audio translation environment in a virtual experience, according to some embodiments.

FIG. 3 is a block diagram of an example audio translation architecture, according to some embodiments.

FIG. 4 is a block diagram of an example audio translation machine-learning model, according to some embodiments.

FIG. 5 is a block diagram of a synthesizer, according to some embodiments.

FIG. 6 includes an example block diagram of a Non-Attentive Tacotron (NAT) synthesizer, according to some embodiments.

FIG. 7 is a flowchart of an example method to train an audio translation machine-learning system to provide audio translation, according to some embodiments.

FIG. 8 is a flowchart of an example method to provide audio translation, according to some embodiments.

FIG. 9 is a block diagram illustrating an example computing device that may be used to implement one or more features described herein, according to some embodiments.

### DETAILED DESCRIPTION

### Overview

Online virtual experience platforms and online gaming platforms (also referred to as “user-generated content platforms” or “user-generated content systems”) offer a variety of ways for users to interact with one another. For example, users of an online virtual experience platform may create games or other content or resources (e.g., characters, graphics, items for game play and/or use within a virtual experience, etc.) within the online platform.

Users of an online virtual experience platform may work together towards a common goal in a metaverse place, game, or in game creation; share various virtual items (e.g., inventory items, game items, etc.); engage in voice chat (e.g., automatic translation of audio streams), send electronic messages to one another, and so forth. Users of an online virtual experience platform may interact with others and play games, e.g., including characters (avatars) or other game objects and mechanisms. An online virtual experience platform may also allow users of the platform to communicate with each other. For example, users of the online virtual experience platform may communicate with each other using voice messages or live voice interaction (e.g., via voice chat with automatic translation), text messaging, video messaging (e.g., including audio translation), or a combination of the above. Some online virtual experience platforms can provide a virtual three-dimensional environment or multiple environments linked within a metaverse, in which users can interact with one another or play an online game.

In order to enhance the entertainment value of an online virtual experience platform, the platform can provide rich audio for playback at a user device. The audio can include, for example, different audio streams from different users, as well as background audio. According to various embodiments described herein, the different audio streams can be captured and automatically translated based on the user that is listening. For example, a first user may request to engage in voice chat with automatic translation with a second user. Thereafter, audio streams from the first user may be translated prior to being provided to the second user, and/or audio streams from the second user may be translated prior to being provided to the first user. Additionally, the audio streams may also be provided to other users with or without automatic translation, for example, based upon user settings, language settings, override settings, and/or other settings.

The audio translation application reduces latency and errors by performing speech-to-speech translation (instead of performing speech-to-text conversion in a first language, translating the text to a second language, and performing text-to-speech conversion in the second language, which are three different processes that each introduce latency and likelihood of errors). The audio translation application translates an audio stream into phonemes in a target language that is different from the source language, predicts respective durations of the phonemes, and uses a synthesizer to generate output speech that includes phonemes with the respective durations. By using an end-to-end model and training the audio translation application using audio training data and synthetic training data, the output speech maintains audio characteristics of the speaker.

As a result of the reduced latency, users can engage in voice chat or other audio interactions with other users that speak different languages without needing to know those languages. The audio translation application advantageously generates translated audio in near real-time (with low latency) so that users may have ongoing conversations with each other without being able to perceive any noticeable delay. This may be used in a virtual environment, such as a game, where users can have conversations despite speaking different languages.

Various embodiments described herein provide output audio in a target language based on input audio in a source language that is different from the target language with low latency, such that users can engage in voice chat in real-time. The embodiments are not language-specific and can support arbitrary language pairs by using appropriately trained machine-learning models, trained using the techniques described herein. Further, the output audio in the target language retains the vocal/audio characteristics of the source language audio. For example, such characteristics can include the style of speaking (speed of speech, intonation, etc.), audio characteristics (speech audio frequencies, speaker age/gender attributes, etc.), content tone (e.g., formal vs casual), and other attributes.

The machine-learning models that perform voice translation as described herein are implemented with specific user permission. Users are provided with clear user interfaces that indicate when voice chat translation is being performed for their input speech. Users can choose to permit/enable or disable the features, and the user speech not processed for translation if the user denies permission. Further, users may choose to configure voice translation such that certain attributes of speech are preserved (e.g., tone), while other attributes are modified (e.g., age-related attributes, gender-related attributes, etc.). The machine-learning models are implemented in a secure manner such that no user speech is stored or can be accessed via the models. The described features are implemented in accordance with applicable rules and regulations for the user locations. Users are also provided with indications when translated speech is played back that the speech has been translated automatically and is not the originally spoken content from the source user. To comply with regulations, speech content may be stored temporarily, with appropriate user permissions and appropriate security practices. In some embodiments, users may be requested to provide their consent for use of their speech data to train or debug machine-learning models that perform translation; such data may be used only if the users provide permission.

### Network Environment

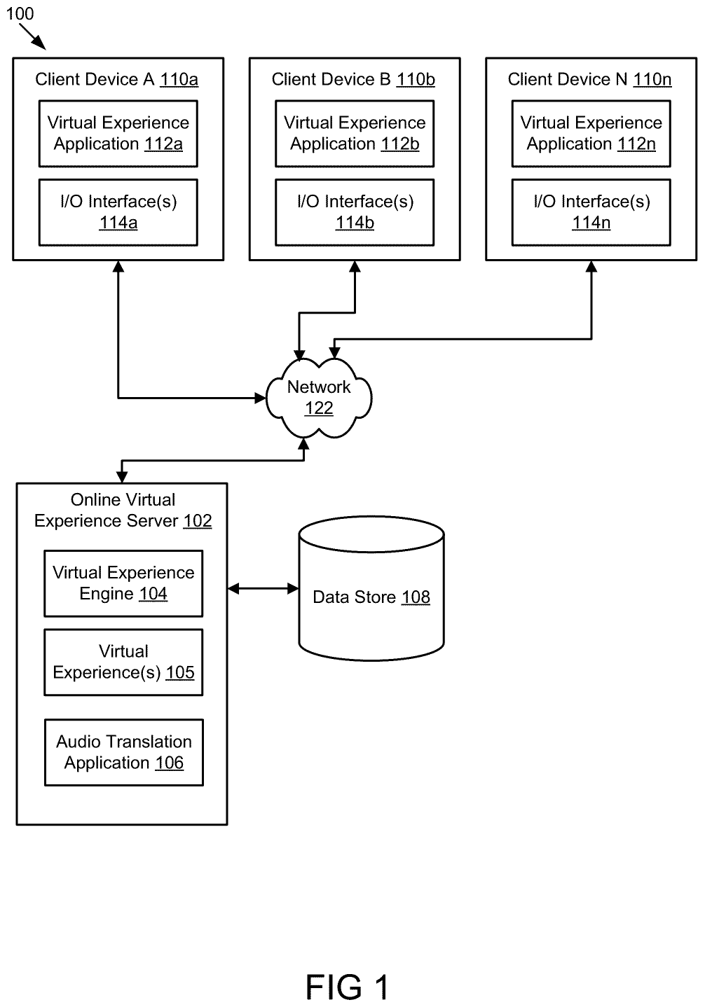

FIG. 1 illustrates an example network environment 100, in accordance with some embodiments of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, and a client device 110 (or multiple client devices), all connected via a network 122.

The online virtual experience server 102 can include, among other things, a virtual experience engine 104, one or more virtual experiences 105, and an audio translation application 106. The online virtual experience server 102 may be configured to provide virtual experiences 105 to one or more client devices 110, and to provide translated audio via the audio translation application 106, in some embodiments.

Data store 108 is shown coupled to online virtual experience server 102 but in some embodiments, can also be provided as part of the online virtual experience server 102. The data store may, in some embodiments, be configured to store advertising data, user data, engagement data, and/or other contextual data in association with the audio translation application 106.

The client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some embodiments, the client devices 110 may be configured to execute and display virtual experiences, which may include virtual user engagement portal s as described herein.

Network environment 100 is provided for illustration. In some embodiments, the network environment 100 may include the same, fewer, more, or different elements configured in the same or different manner as that shown in FIG. 1.

In some embodiments, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some embodiments, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some embodiments, the online virtual experience server 102 can include a server having one or more computing devices (e.g., a cloud computing system, a rackmount server, a server computer, cluster of physical servers, virtual server, etc.). In some embodiments, a server may be included in the online virtual experience server 102, be an independent system, or be part of another system or platform. In some embodiments, the online virtual experience server 102 may be a single server, or any combination a plurality of servers, load balancers, network devices, and other components. The online virtual experience server 102 may also be implemented on physical servers, but may utilize virtualization technology, in some embodiments. Other variations of the online virtual experience server 102 are also applicable.

In some embodiments, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., user 114 via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some embodiments, online virtual experience server 102 may include digital asset and digital virtual experience generation provisions. For example, the platform may provide administrator interfaces allowing the design, modification, unique tailoring for individuals, and other modification functions. In some embodiments, virtual experiences may include two-dimensional (2D) games, three-dimensional (3D) games, virtual reality (VR) games, or augmented reality (AR) games, for example. In some embodiments, virtual experience creators and/or developers may search for virtual experiences, combine portions of virtual experiences, tailor virtual experiences for particular activities (e.g., group virtual experiences), and other features provided through the virtual experience server 102.

In some embodiments, online virtual experience server 102 or client device 110 may include the virtual experience engine 104 or virtual experience application 112. In some embodiments, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some embodiments, each virtual experience 105 may have a different ratio between the virtual experience engine functions that are performed on the online virtual experience server 102 and the virtual experience engine functions that are performed on the client device 110.

In some embodiments, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some embodiments, the client device(s) 110 may each include computing devices such as personal computers (PCs), mobile devices (e.g., laptops, mobile phones, smart phones, tablet computers, or netbook computers), network-connected televisions, gaming consoles, etc. In some embodiments, a client device 110 may also be referred to as a “client device 110.” In some embodiments, one or more client devices 110 may connect to the online virtual experience server 102 at any given moment. It may be noted that the number of client devices 110 is provided as illustration, rather than limitation. In some embodiments, any number of client devices 110 may be used.

In some embodiments, each client device 110 may include an instance of the virtual experience application 112. The virtual experience application 112 may be rendered for interaction at the client device 110. During user interaction within a virtual experience or another GUI of the online platform 100, a user may create an avatar that includes different body parts from different libraries. The audio translation application 106 may take as input audio streams from users participating in the virtual experience and output audio that is translated based on a language preference for a user associated with a client device 110 that receives the output audio.

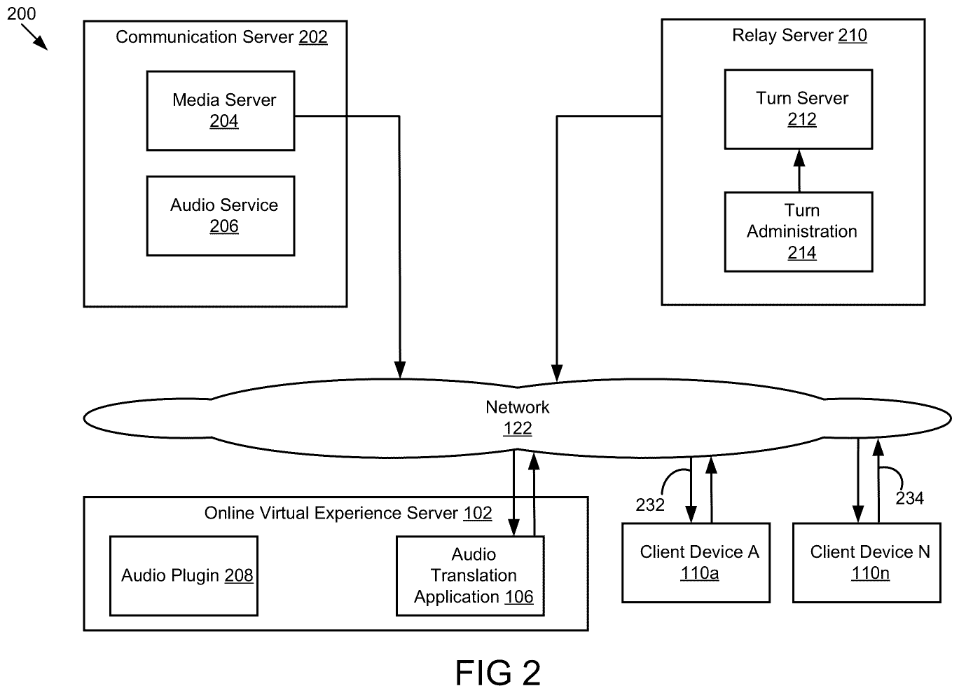

Hereinafter, operation of the online virtual experience server 102 with regard to providing automatic audio translation, is described more fully with reference to FIG. 2.

### Audio Translation Environment

FIG. 2 is a diagram of an example audio translation environment 200 (e.g., a subset of the network environment 100) for providing automatic audio translation in a virtual experience, according to some embodiments. Network environment 200 is provided for illustration. In some embodiments, the network environment 200 may include the same, fewer, more, or different elements configured in the same or different manner as that shown in FIG. 2.

As shown in FIG. 2, the online virtual experience server 102 may be in communication with client device 110 and client device 116 such that an audio stream 232 is received from the client device 110, and a translated audio stream 234 is provided for output at the client device 116, over the network 122. The online virtual experience server 102 may also be in communication with communication server 202 and relay server 210 over the network 122.

The online virtual experience server 102, in addition to those components illustrated in FIG. 1, may include an audio plugin 208 for communication with the communication server 202. The audio plugin 208 may perform the separation of audio streams and/or the identification of audio streams to be translated by the audio translation application 106. In this manner, while the audio stream 232 may be sent in its native (untranslated) form to any client device 110, the audio plugin 208 may also indicate to the media server 204 that translated versions of the audio stream 232 are to be provided to other client devices 110. Accordingly, the audio plugin 208 may both allow native communication and translated communication to occur at substantially the same or similar times.

The communication server 202 may be a third-party communication server and/or a separate server existing within the audio translation environment 200. The communication server 202 may include a media server 204 in operative communication with an audio service 206.

The media server 204 is a server configured to connect and communicate audio streams (or other data) between components of the audio translation environment 200. The media server 204 may facilitate real-time communication, for example, among various client devices 110 and between each client device 110 and the online virtual experience server 102.

The audio service 206 may be a software service configured to enable voice chat and/or video chat (with audio) between client devices and the online virtual experience server 102.

The relay server 210 may be a third-party relay server and/or a separate server existing on the audio translation environment 200. The relay server 210 may include a turn server 212 in operative communication with a turn administration component 214.

The turn server 212 may implement a Traversal Using Relay NAT (TURN) protocol. It may relay network traffic. For example, the turn server 212 may support communication between client devices 110 and 116 over network 122.

The turn administration component 214 may implement communication protocols and control messaging with the turn server 212, in addition to other functions.

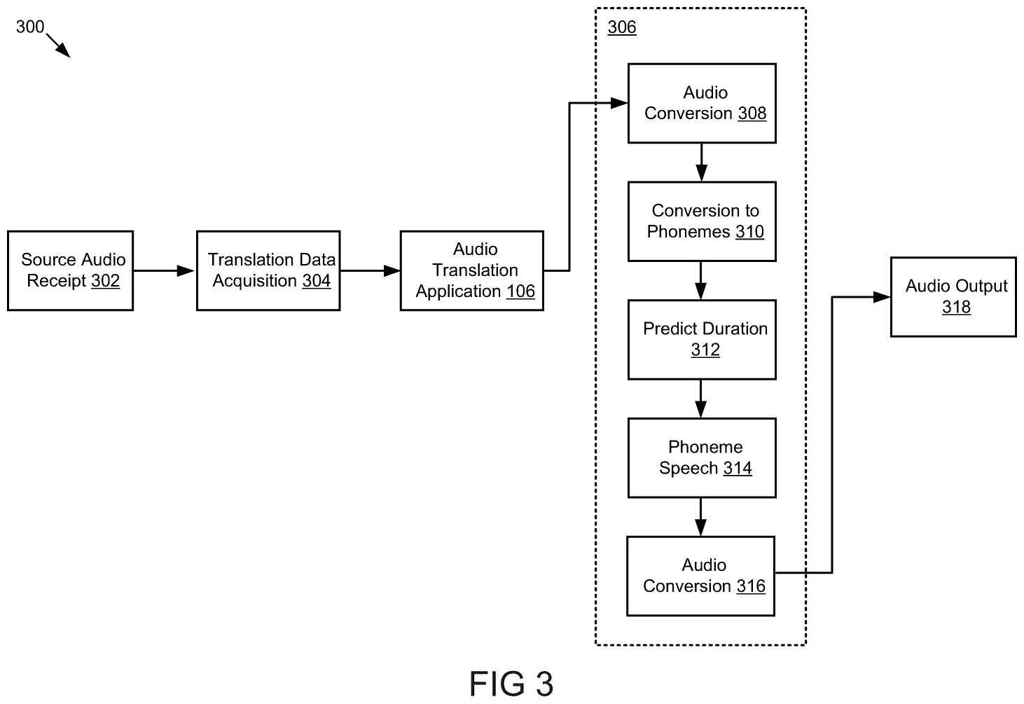

Hereinafter, translation of audio for chat, utilizing the audio translation application 106 and available translation data, is described more fully with reference to FIG. 3.

### Audio Translation Architecture

FIG. 3 is a diagram of an example audio translation architecture 300 for automatically translating audio streams (e.g., voice chats including audio chats and video chats with audio) in a virtual experience, according to some embodiments. The audio translation architecture 300 is provided for illustration. In some embodiments, the audio translation architecture 300 may include the same, fewer, more, or different elements configured in the same or different manner as the elements illustrated in FIG. 3.

As shown in FIG. 3, the audio translation architecture 300 receives source audio from a voice chat (or a video chat) at stage 302. The source audio is spoken in a first language by a first user. The source audio may be associated with translation data that is acquired at stage 304. The translation data may include user settings for translation, including a language preference associated with a second user, and other user settings.

Upon acquisition of the translation data and the receipt of audio, the audio translation application 106 may begin translation (e.g., as shown in the dotted box 306).

At stage 308 the source audio may be converted from a form received from the communication server 202 into another format suitable for text extraction. For example, if the media server 204 uses a first format (e.g., OPUS), the stage 308 may include converting from the first format into the second format (e.g., WAV). In some embodiments, the stage 308 also includes tokenization of the audio stream and encoding of a tokenized audio stream. Stage 308 is followed by stage 310.

At stage 310, the converted audio is converted into phonemes of a second language based on the language preference. In some embodiments, a trained machine-learning model, such as phoneme decoder, is used to convert the audio into phonemes. Stage 310 is followed by stage 312.

At stage 312, a duration of each of the phonemes in the plurality of phonemes is predicted. In some embodiments, a trained machine-learning model, such as a transformer encoder, is used to predict a duration of each of the phonemes. In some embodiments, a variance of each phoneme is also predicted by a different transformer encoder. Stage 312 is followed by stage 314.

At stage 314, the phonemes are converted into output speech with a speech synthesizer. The output speech includes the phonemes where each of the phonemes has a respective duration. Stage 314 is followed by stage 316.

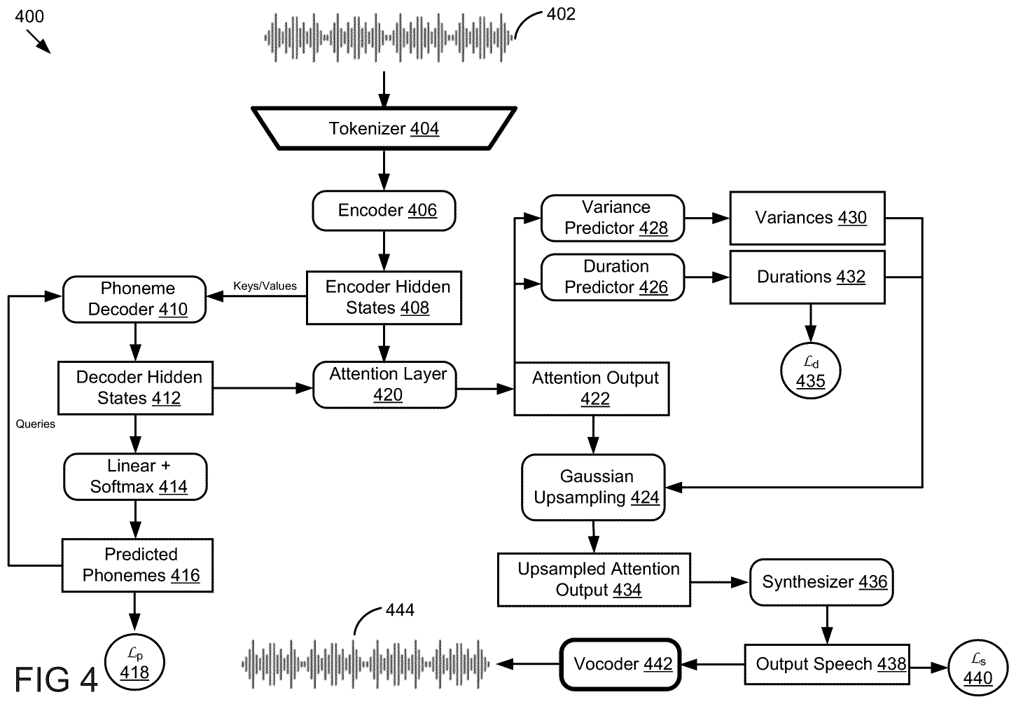

At stage 316, the output speech is (optionally) converted from the second format back into the first format. For example, the output speech may be converted from encoded audio to a waveform by a vocoder. Stage 316 is followed by audio output stage 318. In this manner, the audio output stage 318 may provide an audio stream that can be input by the media server 204 and directed to a client device 110 in a similar manner as un-translated voice chats. Hereinafter, further details related to machine-learning model architecture are provided with reference to FIGS. 4-7.

### Audio Translation Machine-Learning Model

FIG. 4 is a block diagram of an example audio translation machine-learning model 400, according to some embodiments. An audio stream 402 is provided as input to a tokenizer 404. The audio stream 402 is in a waveform format, such as OPUS, WAVE, WAV, etc. The audio stream 402 may be received from a first user associated with a first client device. The audio stream 402 may be spoken in a first language by the first user.

The tokenizer 404 may include any suitable tokenizer configured to tokenize the audio stream 402 as an embedding. For example, the tokenizer 404 may generate a spectrogram, such as a Mel Spectrogram. The tokenizer 404 may include a Mel Spectrogram conversion tokenizer, a Vector Quantized Variational Autoencoder (VQ-VAE), a Griffin-Lim tokenizer, a neural-audio codec tokenizer, and/or others. A tokenized audio stream may be output from the tokenizer 404 and provided as input to an encoder 406.

An encoder 406 may be configured to receive the tokenized input speech and output encoded data (e.g., a vector representation of the audio stream) in the form of encoder hidden states 408. Each encoder hidden state 408 may be constructed by summing a token embedding generated by the tokenizer 404 with a position embedding that reflects the position of each token embedding in relation to subsequent token embeddings.

The encoder 406 may be based on any suitable audio encoder machine learning model trained to encode audio from tokenized input speech. In some embodiments, the encoder 406 includes a transformer and convolution neural network (CNN) model. Other encoders may also be suitable. The encoder hidden states 408 are used as keys and values by a phoneme decoder 410.

The encoder hidden states 408 from the encoder 406 are received by the phoneme decoder 410. The phoneme decoder 410 is trained to output phonemes of a target language utterance that is different from the language used in the audio stream. In some embodiments, the phoneme decoder 410 receives translation data associated with a second user and the translation data includes a language preference.

In some embodiments, the phoneme decoder 410 is a transformer decoder with rotary embeddings. Rotary embeddings are used to encode positional information to include both an absolute position of tokens and the relative distances between pairs of tokens. A rotational mechanism represents each position in a sequence by a rotation of an audio vector in an embedding space. The rotation has an angle of rotation that is proportional to a position of a discrete portion of the audio stream.

The phoneme decoder 410 includes a linear transformation and SoftMax function 414 that are used to output predicted phonemes 416 in a target language based on the vector representation of the audio stream output from the encoder 406. A SoftMax activation function converts raw output scores into probabilities. For example, each predicted phoneme 416 may be selected from a set of predicted phonemes 416 with associated output scores that the SoftMax activation function uses to predict corresponding probabilities of accuracy. A predicted phoneme 416 may be selected from the set based on having the highest probability of accuracy.

Phonemes are perceptually distinct units of sounds in a specified language that distinguish one word from another. For example, the English phoneme /k/ occurs in words, such as cat, kit, scat, and skit.

The process of predicting phonemes is an autoregressive process. For example, linear transformation and SoftMax function 414 may output a first predicted phoneme 416. The first predicted phoneme 416 is used as part of a first query that is paired with a first key and a first value based on the vector representation of the audio stream to perform multi-headed attention. Rotary positional encodings and a causal attention mask may be implemented on the queries. The first predicted phoneme 416 is used to predict a subsequent predicted phoneme 416 because phonemes are grouped together as a function of language. Continuing with the example above, if the first phoneme is /k/, the next phoneme may be /ă/ or /ĭ/ based on a likelihood of /k/ being grouped with /ă/ or /ĭ/ to make “cat” or “kit,” respectively.

The phoneme decoder 410 predicts a subsequent predicted phoneme 416, which is used to generate a subsequent query. The subsequent query is combined with a subsequent key and a subsequent value to output predicted phonemes 416 with the phoneme decoder 410 until a remaining vector representation of the audio stream is processed.

An attention layer 420 receives both encoder hidden states 408 from the encoder 406 and decoder hidden states 412 (e.g., vectors that correspond to the phonemes) from the phoneme decoder 410. The attention layer 420 may induce alignment between predicted phonemes, as described by the decoder hidden states 412, and speaker characteristics, as captured by the encoder hidden states 408.

In some embodiments, the attention layer 420 is a single multi-headed cross-attention layer that uses the encoder hidden states 408 as keys and values and uses the decoder hidden states 412 as queries to extract features from the audio stream that may be useful for voice cloning by the synthesizer 436. In some embodiments, the attention layer 420 does not use masking or autoregression and is not active until the phoneme decoder 410 completes its autoregressive process.

The attention layer 420 outputs attention output 422 (e.g., output feature vectors based on the vectors that correspond to the phonemes and the vector representation of the audio stream). The attention output 422 is received by a duration predictor 426 and by a variance predictor 428.

The duration predictor 426 predicts durations 432 of each phoneme based on the extracted features described by the attention output 422. In some embodiments, the duration predictor 426 includes a transformer encoder with output dimension 1 and uses a softplus activation function. The softplus activation function ensures that the output is positive, which is used by the Gaussian upsampling component 424 to calculate a positive standard deviation output.

The variance predictor 428 predicts variances 430 of each phoneme. In some embodiments, the variance predictor 428 includes a transformer encoder with output dimension 1 and softplus activation.

A Gaussian upsampling component 424 receives the attention output 422 (e.g., the output feature vectors) from the attention layer 420, the variances 430, and the durations 432. The Gaussian upsampling component 424 upsamples the output feature vectors and outputs an upsampled attention output 434 to an input rate (e.g., a frequency) of the synthesizer 436. The Gaussian upsampling component 424 effectively up-samples the attention output 422 along a time axis until the number of dimensions on that axis equals the number of spectrogram frames needed for the upsampled attention output 434 to have the duration specified by the duration predictor 426. For example, the upsampled attention output 434 may have one vector per time step. The upsampled attention output 434 contains information in the predicted phonemes that is used to output speaker characteristics in the same voice as the audio stream 402. The upsampling layer performs resampling to obtain this time correspondence.

A synthesizer 436 receives the upsampled attention output 434 from the Gaussian upsampling component 424 to create a synthesized speech waveform that retains speaker characteristics from the audio stream 402. In some embodiments, the audio translation machine-learning model 400 is trained using a first type of synthesizer and after training the first type of synthesizer is replaced with a second type of synthesizer. For example, the first type of synthesizer may be a Non-Attentive Tacotron (NAT)-based synthesizer and the second type of synthesizer is a diffusion synthesizer. Additional details about the NAT-based synthesizer and the diffusion synthesizer are provided below with reference to training the audio translation machine-learning model 400. The synthesizer 436 outputs output speech 438 that is received by the vocoder 442. The output speech 438 has a one-to-one time correspondence with the upsampled attention output 434. In some embodiments, the output speech 438 includes hidden states of an audio codec.

The output from synthesizer 436 is received by a vocoder 442 that synthesizes the human voice signal for voice transformation. The vocoder 442 outputs an audio stream 444 in a waveform format.

The audio translation machine-learning model 400 performs translation as an ongoing process where the audio stream 402 is continually updated with additional input and the vocoder 442 continually outputs subsequent updates to the audio stream 444.

### Training of Audio Translation Machine-Learning Model

The audio translation machine-learning model 400 is trained to perform zero-shot speaker preservation, which is translation of audio without providing additional information to the audio translation machine-learning model 400. In some embodiments, the audio translation machine-learning model 400 undergoes different types of training. For example, the audio translation machine-learning model 400 may be trained in four stages. First, the diffusion synthesizer 436 is pretrained on unlabeled audio. The training data used for the diffusion synthesizer 436 may include diverse voices to train the diffusion synthesizer 436 on complex voice-cloning tasks.

Second, the encoder 406 and phoneme decoder 410 are trained on speech-to-text translation tasks where the loss is defined as a predictor loss (Lₚ) 418, which is obtained from predicted phonemes 416 from the phoneme decoder 410. In some embodiments, the audio translation application 106 generates audio training data that is used for the speech-to-text translation tasks during training of the encoder 406 and phoneme decoder 410. For example, the audio translation application 106 identifies audio that may be used for audio training data. If the speech is not associated with transcriptions, the audio translation application 106 transcribes the speech using a speech-to-text model and translates the transcriptions to target languages.

In some embodiments, the audio translation application 106 generates synthetic training data that is used for the speech-to-text translation tasks during training of the encoder 406 and phoneme decoder 410. For example, the audio translation application 106 may prompt a chatbot to generate text in a style associated with a virtual experience from a chatbot, translate the text to source audio in one or more different languages, and use the text as ground truth data. For example, the chatbot may be prompted for text in English. Translations of the English text are provided as input for translation and compared against the English text as ground truth data for determining the predictor loss (Lₚ) 418.

Third, the audio translation machine-learning model 400 is trained with the NAT synthesizer 436 on both speech-to-text translation tasks and speech-to-speech translation tasks simultaneously on different datasets where the loss is defined as a weighted sum of three losses: the predictor loss (Lₚ) 418, a duration loss (L_{d}) 435, and a synthesizer loss (Lₛ) 440. More specifically, the encoder 406 and phoneme decoder 410 may be trained on speech-to-text translation tasks and all components of the audio translation machine-learning model 400 are trained on speech-to-speech translation tasks. The third step may prevent overfitting on a smaller training dataset and enhances translation quality.

Fourth, the NAT synthesizer 436 is replaced with the diffusion synthesizer 436 and all parameters except the parameters associated with the diffusion synthesizer 436 are frozen. The loss for the fourth step may be defined as a weighted sum of the duration loss (L_{d}) 435 and the synthesizer loss (Lₛ) 440.

In some embodiments, the audio translation machine-learning model 400 includes a first portion of components that learning parameters through training and a second portion of components with frozen parameters. For example, in FIG. 4 the tokenizer 404 and vocoder 442 (shown in boxes with bold borders) may be associated with frozen parameters. In some embodiments, the encoder 406 is trained using a pre-existing encoder with pretrained weights. During training, the predictor loss (Lₚ) 418 is calculated as a cross-entropy loss that is applied to the phoneme decoder 410. The duration predictor 426 is trained using supervised training directly with ground truth, per-phoneme durations with the duration loss (L_{d}) 435 calculated as an L₂ loss. The variance predictor 428 is trained using implicit training by a final loss term from the synthesizer 436. In some embodiments, the gradients are stopped (e.g., zeroed out) before both the duration predictor 426 and the variance predictor 428 are trained to improve training stability by keeping the duration predictor 426 and the variance predictor 428 in their previous states. In some embodiments, the variance predictor 428 receives gradients from the synthesizer 436. The Gaussian upsampling component 424 may be trained using ground truth durations and the predicted variances 430 output by the variance predictor 428.

In some embodiments, the audio translation machine-learning model 400 is trained with a NAT-based synthesizer 436. After the audio translation machine-learning model 400 is trained, the NAT-based synthesizer 436 is replaced with a diffusion synthesizer 436. The audio translation machine-learning model 400 parameters are frozen while the diffusion synthesizer 436 is fine tuned. In some embodiments, the synthesizer loss (Lₛ) 440 is based on masked L₁ and L₂ losses from the autoregressive Long-Short Term Memory (LSTM) model output. In some embodiments, a residual convolutional multilayer perceptron is applied to a preliminary output using the same loss function.

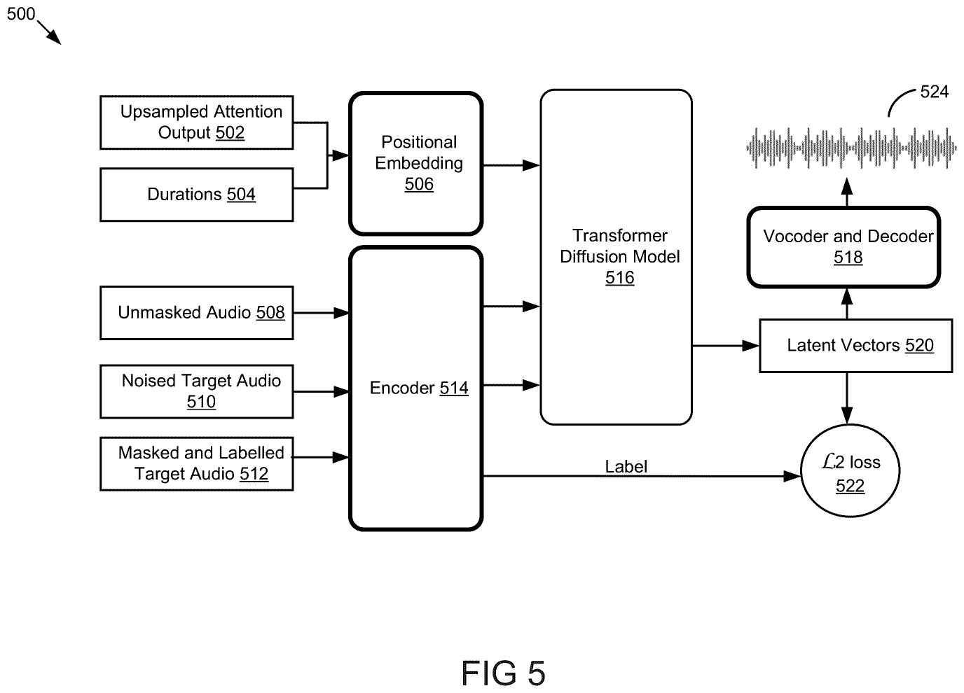

Turning to FIG. 5, a block diagram of the diffusion synthesizer 500 is illustrated, according to some embodiments. The diffusion synthesizer 500 includes a positional embedding component 506, an encoder 514, a transformer diffusion model 516, and a vocoder and decoder 518. In some embodiments, the bolded components (the positional embedding component 506, the encoder 514, and the vocoder and decoder 518) have frozen parameters while the remaining components (e.g., transformer diffusion model 516) are trained (their parameters are adjusted) during training.

The diffusion synthesizer 500 is pretrained on unlabeled audio data. As a result, the diffusion synthesizer 500 is trained to output speech for diverse voices. In some embodiments, the unlabeled audio data is masked audio. In some embodiments, the masked audio may be randomly generated.

After pretraining, training includes providing upsampled attention output 502 and durations 504 to a positional embedding component 506. In some embodiments, the positional embedding component 506 includes a multilayer perceptron network that outputs upsampled embeddings that are in the same dimension as the transformer diffusion model 516. The positional embedding component 506 outputs a positional encoding that is derived from the durations 504 and applied to the upsampled embeddings. The result is provided as input to the transformer diffusion model 516.

The encoder 514 receives unmasked audio 508, noised target audio 510, and masked and labelled target audio 512. The transformer diffusion model 500 uses the three audio samples during training to predict how to receive the masked and labelled target audio 512 as input to the diffusion synthesizer 500 and compare the result (i.e., the latent vectors 520) to the unmasked audio 508, which serves as ground truth data. The noised target audio 510 is used to train the diffusion synthesizer 500 to perform reverse diffusion to remove noise from a signal.

The encoder 514 outputs audio tokens for the unmasked audio 508, the noised target audio 510, and the masked and labelled target audio 512, respectively. The encoder 514 also outputs labels that are compared to latent vectors 520 to determine an L2 loss. In some embodiments, the L2 loss 522 is a masked loss.

The positional encoding and the audio tokens are provided as input to the transform diffusion model 516, which is trained based on the comparisons of the different audio tokens and the positional encoding to predict denoised latent vectors 520. The latent vectors 520 are used to calculate the L2 loss 522 directly. The latent vectors 520 are received by the vocoder and decoder 518. The vocoder and decoder 518 generate output audio 524 (e.g., waveforms).

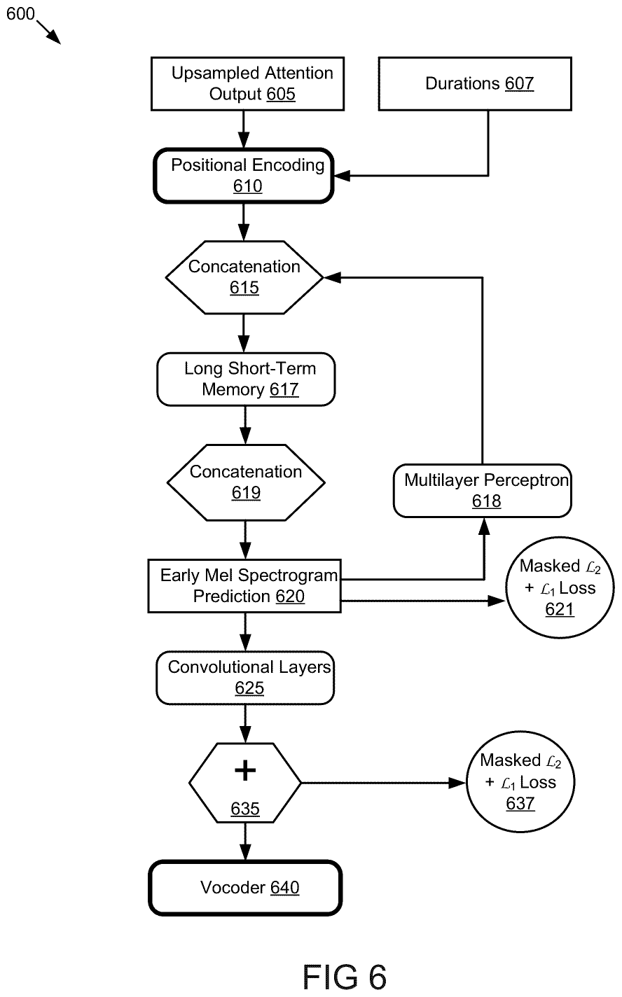

FIG. 6 includes an example block diagram of a Non-Attentive Tacotron (NAT) synthesizer 600, according to some embodiments. The upsampled attention output 605 and predicted durations 607 are received by a positional encoding component 610. The positional encoding component 610 applies a positional encoding to the upsampled attention output 605 and outputs embedding and positional encodings that are concatenated by the concatenation component 615.

The output is passed through an autoregressive LSTM model 617. The LSTM output is concatenated with the positionally encoded upsampler output by a concatenation component 619 and passed through a dense layer to get an early Mel Spectrogram prediction 620.

The early Mel Spectrogram prediction 620 is passed through a multilayer perceptron 618 and then concatenated with a positionally-encoded upsampled attention output by being provided to the earlier concatenation component 615 and the process continues during training. The early Mel Spectrogram predictions 620 are used to calculate a masked L2 and L1 loss 621 during training.

The early Mel Spectrogram predictions 620 are also provided to convolutional layers 625. The convolutional layers 625 output features that are combined 635 to form a Mel Spectrogram that is used to calculate a masked L2 and L1 loss 637 during training. The Mel Spectrogram is provided to a vocoder 640, which outputs audio as a waveform.

Different enhancements to the above-described teachings may be performed to improve one or more aspects of end-to-end speech translations.

In some embodiments, both the decoder and synthesizer may be implemented as streaming. The decoder may be polled at fixed intervals for new phonemes and speak whenever a new phoneme is ready. The upsampling method may also be windowed. It is noted that decoder and synthesizer streaming may require no changes to the synthesizer.

In some embodiments, a k-nearest-neighbor lookup system may be implemented in the phoneme decoder to facilitate faster next-token-prediction during streaming inference. A vector database may be stored, with mapping decoder hidden states to phoneme sequences pulled from audio streams. Then, during inference, the vector database may be leveraged to check if a specific phoneme is likely to come next given what is usually said in audio streams.

In some embodiments, models may be trained on artificially aligned utterances in different languages with the same meaning. To do this, a speaker embedding may be added into the model, as the data will have different input and output speakers. An output speaker embedding may be added to the synthesizer at train time, while having the encoder attempt to predict the speaker embedding of its input. In this manner, at inference time, a separate speaker embedding network may not be necessary.

### Methods

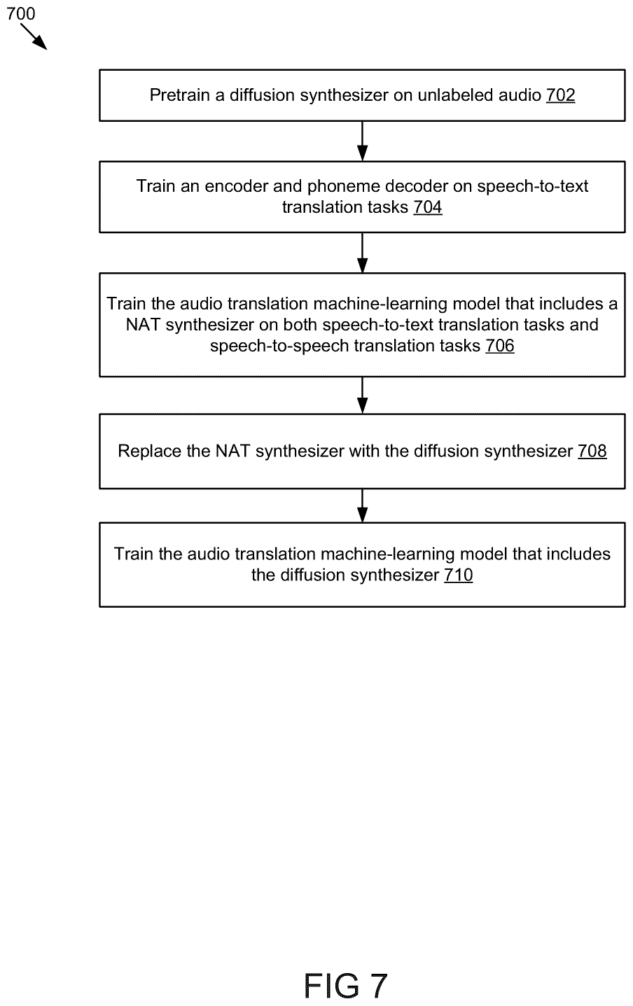

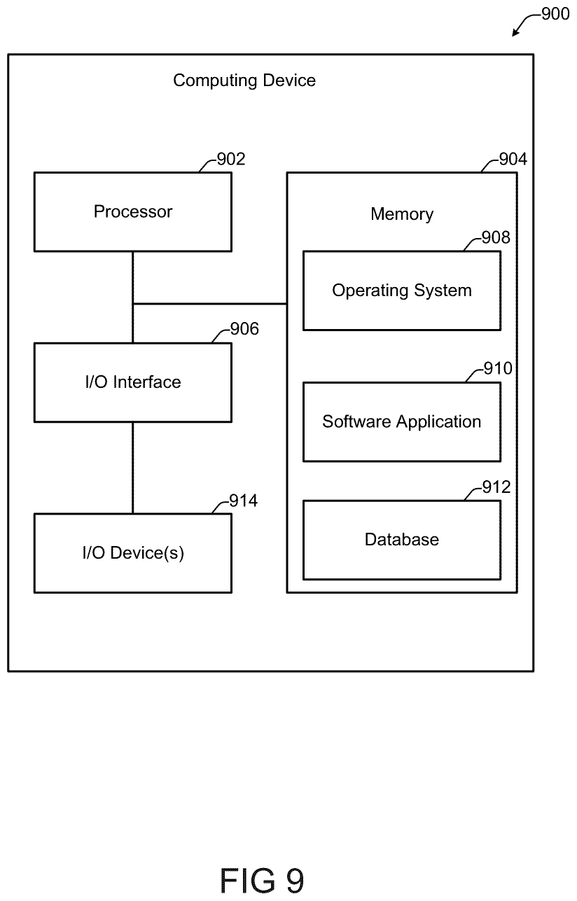

FIG. 7 is a flowchart of an example method 700 to train an audio translation machine-learning system to provide audio translation, according to some embodiments. The method 700 may be performed by the computing device 900 in FIG. 9 (e.g., that may be configured as a client device 110 or virtual experience server 102).

The method 700 may begin with block 702. At block 702, a diffusion synthesizer is pretrained on unlabeled audio. Block 702 may be followed by block 704.

At block 704 an encoder and phoneme decoder are trained on speech-to-text translation tasks. A predictor loss (Lₚ) is determined during the training. Block 704 may be followed by block 706.

At block 706, an audio translation machine-learning model that includes a NAT synthesizer is trained on both speech-to-text translation tasks and speech-to-speech translation tasks. The predictor loss (Lₚ), a duration loss (L_{d}), and a synthesizer loss (Lₛ) are determined during training. In some embodiments, the loss is a weighted sum of the predictor loss (Lₚ), the duration loss (L_{d}), and the synthesizer loss (Lₛ). Block 706 may be followed by block 708.

At block 708, the NAT synthesizer is replaced with the diffusion synthesizer. Block 708 may be followed by block 710.

At block 710, the audio translation machine-learning model that includes the diffusion synthesizer is trained. A loss is determined during training. In some embodiments, the loss is a weighted sum of the duration loss (L_{d}) and the synthesizer loss (Lₛ). In some embodiments, during training of the diffusion synthesizer, other blocks of the model are frozen (e.g., their parameters are fixed) while the diffusion synthesizer parameters are adjusted.

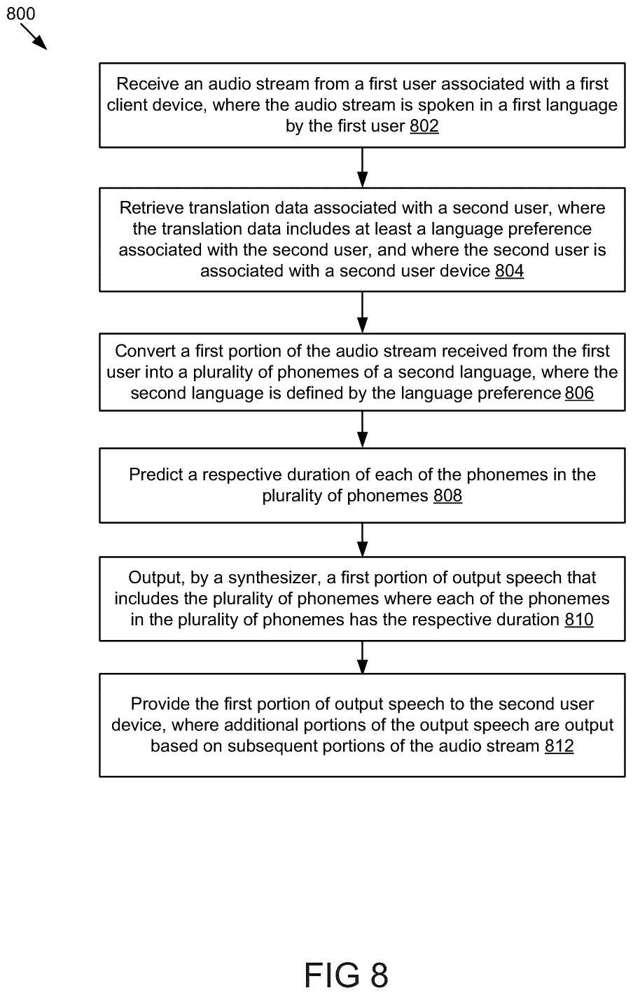

FIG. 8 is a flowchart of an example method 800 to provide audio translation, according to some embodiments. The method 800 may be performed by the computing device 900 in FIG. 9 (e.g., that may be configured as a client device 110 or virtual experience server 102).

The method 800 may begin at block 802. At block 802, an audio stream is received from a first user associated with a first client device, where the audio stream is spoken in a first language by the first user.

In some embodiments, before block 802, the method 800 includes providing the first portion the audio stream as input to a tokenizer; providing output from the tokenizer as input to an encoder; and outputting, with the encoder, a vector representation of the audio stream, wherein the first portion of the audio stream that is converted is the vector representation of the audio stream. In some embodiments, converting the vector representation of the audio stream into the plurality of phonemes includes: outputting, with a phoneme decoder, a first predicted phoneme of the plurality of phonemes; generating a first query from the first predicted phoneme; providing the first query, and a first key and a first value based on the vector representation of the audio stream to the phoneme decoder; outputting, with the phoneme decoder, a subsequent predicted phoneme of the plurality of phonemes; generating a subsequent query from the subsequent predicted phoneme; providing the subsequent query, and a subsequent key and a subsequent value based on the vector representation of the audio stream to the phoneme decoder; and continuing to predict phonemes with the phoneme decoder until a remaining vector representation of the audio stream is processed.

In some embodiments, predicting a duration of each of the phonemes in the plurality of phonemes includes: receiving, at an attention layer and from a phoneme decoder, a plurality of vectors that correspond to the plurality of phonemes; converting, by the attention layer, the plurality of vectors into respective queries; and generating, by the attention layer, output feature vectors based on the plurality of vectors that correspond to the plurality of phonemes and the vector representation of the audio stream. In some embodiments, the method 800 further includes providing the output feature vectors to a variance predictor that predicts a variance of each phoneme of the plurality of phonemes. In some embodiments, the method further includes providing the output feature vectors to a duration predictor, wherein predicting the respective duration of each of the phonemes in the plurality of phonemes is performed using the duration predictor. In some embodiments, the method further includes prior to outputting the first portion of the output speech, performing Gaussian upsampling of the output feature vectors, wherein the Gaussian upsampling is performed to an input rate of the synthesizer. Block 802 may be followed by block 804.

At block 804, translation data associated with a second user is received, where the translation data includes at least a language preference associated with the second user, and where the second user is associated with a second user device. Block 804 may be followed by block 806.

At block 806, a first portion of the audio stream received from the first user is converted into a plurality of phonemes of a second language, where the second language is defined by the language preference. Block 806 may be followed by block 808.

At block 808, a respective duration of each of the phonemes in the plurality of phonemes is predicted. Block 808 may be followed by block 810.

At block 810, a synthesizer outputs a first portion of output speech that includes the plurality of phonemes where each of the phonemes in the plurality of phonemes has the respective duration. In some embodiments, the first portion of output speech includes hidden states corresponding to the plurality of phonemes, and the method 800 further includes before providing the first portion of output speech to the second user device, transforming the hidden states corresponding to the plurality of phonemes into audio using a vocoder. In some embodiments, the synthesizer is trained by training a first synthesizer using a synthesizer loss, replacing the first synthesizer with a diffusion synthesizer, and fine-tuning the diffusion synthesizer. Block 810 may be followed by block 812.

At block 812, the first portion of output speech is provided to the second user device, where additional portions of the output speech are output based on subsequent portions of the audio stream. In some embodiments, the audio stream is associated with a voice chat function of a virtual experience.

### Computing Device

Hereinafter, a more detailed description of various computing devices that may be used to implement different devices, methods, and/or operations illustrated in FIGS. 1-8 is provided with reference to FIG. 9.

FIG. 9 is a block diagram of an example computing device 900 which may be used to implement one or more features described herein, according to some embodiments. In one example, device 900 may be used to implement a computer device, (e.g., 102, 110, and/or 116 of FIG. 1), and perform appropriate method embodiments described herein. Computing device 900 can be any suitable computer system, server, or other electronic or hardware device. For example, the computing device 900 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some embodiments, device 900 includes a processor 902, a memory 904, input/output (I/O) interface 906, and audio/video input/output devices 914 (e.g., display screen, touchscreen, display goggles or glasses, audio speakers, headphones, microphone, etc.).

Processor 902 can be one or more processors and/or processing circuits to execute program code and control basic operations of the device 900. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 904 is typically provided in device 900 for access by the processor 902, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 902 and/or integrated therewith. Memory 904 can store software operating on the computing device 900 by the processor 902, including an operating system 908, applications 910 and associated database 912. In some embodiments, the applications 910 can include instructions that enable processor 902 to perform the functions described herein, e.g., some or all of the methods or operations of FIGS. 7 and 8.

For example, memory 904 can include software instructions for automatically translating voice chat in a metaverse place. Any of software in memory 904 can alternatively be stored on any other suitable storage location or computer-readable medium. In addition, memory 904 (and/or other connected storage device(s)) can store instructions and data used in the features described herein. Memory 904 and any other type of storage (magnetic disk, optical disk, magnetic tape, or other tangible media) can be considered “storage” or “storage devices.”

I/O interface 906 can provide functions to enable interfacing the computing device 900 with other systems and devices. For example, network communication devices, storage devices (e.g., memory and/or data store 108), and input/output devices can communicate via interface 906. In some embodiments, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 9 shows one block for each of processor 902, memory 904, I/O interface 906, software blocks 908 and 910, and database 912. These blocks may represent one or more processors or processing circuitries, operating systems, memories, I/O interfaces, applications, and/or software modules. In other embodiments, device 900 may not have all of the components shown and/or may have other elements including other types of elements instead of, or in addition to, those shown herein. While the online virtual experience server 102 is described as performing operations as described in some embodiments herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the device 900, e.g., processor(s) 902, memory 904, and I/O interface 906. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 914, for example, can be connected to (or included in) the device 900 to display images pre- and post-processing as described herein, where such display device can include any suitable display device, e.g., an LCD, LED, or plasma display screen, CRT, television, monitor, touchscreen, 3-D display screen, projector, or other visual display device. Some embodiments can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various embodiments. In some embodiments, blocks and operations can be performed multiple times, in a different order, and/or at different times in the methods.

In some embodiments, some or all of the methods can be implemented on a system such as one or more client devices. In some embodiments, one or more methods described herein can be implemented, for example, on a server system, and/or on both a server system and a client system. In some embodiments, different components of one or more servers and/or clients can perform different blocks, operations, or other parts of the methods.

One or more methods described herein (e.g., method 800) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular embodiments thereof, these particular embodiments are merely illustrative, and not restrictive. Concepts illustrated in the examples may be applied to other examples and embodiments.

In situations in which certain embodiments discussed herein may obtain or use user data (e.g., user demographics, user behavioral data on the platform, user search history, items purchased and/or viewed, user's friendships on the platform, etc.) users are provided with options to control whether and how such information is collected, stored, or used. That is, the embodiments discussed herein collect, store and/or use user information upon receiving explicit user authorization and in compliance with applicable regulations.

Users are provided with control over whether programs or features collect user information about that particular user or other users relevant to the program or feature. Each user for which information is to be collected is presented with options (e.g., via a user interface) to allow the user to exert control over the information collection relevant to that user, to provide permission or authorization as to whether the information is collected and as to which portions of the information are to be collected. In addition, certain data may be modified in one or more ways before storage or use, such that personally identifiable information is removed. As one example, a user's identity may be modified (e.g., by substitution using a pseudonym, numeric value, etc.) so that no personally identifiable information can be determined. In another example, a user's geographic location may be generalized to a larger region (e.g., city, zip code, state, country, etc.).

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular embodiments. Different programming techniques may be employed, e.g., procedural or object-oriented. The routines may execute on a single processing device or multiple processors. Although the steps, operations, or computations may be presented in a specific order, the order may be changed in different particular embodiments. In some embodiments, multiple steps or operations shown as sequential in this specification may be performed at the same time.

What is claimed is:

1. A computer-implemented method of audio translation comprising:
receiving an audio stream from a first user associated with a first client device, wherein the audio stream is spoken in a first language by the first user;
retrieving translation data associated with a second user, wherein the translation data includes at least a language preference associated with the second user, and wherein the second user is associated with a second user device;
converting a first portion of the audio stream received from the first user into a plurality of phonemes of a second language, wherein the second language is defined by the language preference;
predicting a respective duration of each of the phonemes in the plurality of phonemes;
outputting, by a synthesizer, a first portion of output speech that includes the plurality of phonemes where each of the phonemes in the plurality of phonemes has the respective duration; and
providing the first portion of output speech to the second user device;
wherein additional portions of the output speech are output based on subsequent portions of the audio stream.

2. The method of claim 1, further comprising:
providing the first portion the audio stream as input to a tokenizer;
providing output from the tokenizer as input to an encoder; and
outputting, with the encoder, a vector representation of the audio stream, wherein the first portion of the audio stream that is converted is the vector representation of the audio stream.

3. The method of claim 2, wherein converting the vector representation of the audio stream into the plurality of phonemes includes:
outputting, with a phoneme decoder, a first predicted phoneme of the plurality of phonemes;
generating a first query from the first predicted phoneme;
providing the first query, and a first key and a first value based on the vector representation of the audio stream to the phoneme decoder;
outputting, with the phoneme decoder, a subsequent predicted phoneme of the plurality of phonemes;
generating a subsequent query from the subsequent predicted phoneme;
providing the subsequent query, and a subsequent key and a subsequent value based on the vector representation of the audio stream to the phoneme decoder; and
continuing to predict phonemes with the phoneme decoder until a remaining vector representation of the audio stream is processed.

4. The method of claim 2, wherein predicting a duration of each of the phonemes in the plurality of phonemes includes:
receiving, at an attention layer and from a phoneme decoder, a plurality of vectors that correspond to the plurality of phonemes;
converting, by the attention layer, the plurality of vectors into respective queries; and
generating, by the attention layer, output feature vectors based on the plurality of vectors that correspond to the plurality of phonemes and the vector representation of the audio stream.

5. The method of claim 4, further comprising providing the output feature vectors to a variance predictor that predicts a variance of each phoneme of the plurality of phonemes.

6. The method of claim 4, further comprising providing the output feature vectors to a duration predictor, wherein predicting the respective duration of each of the phonemes in the plurality of phonemes is performed using the duration predictor.

7. The method of claim 4, further comprising prior to outputting the first portion of the output speech, performing Gaussian upsampling of the output feature vectors, wherein the Gaussian upsampling is performed to an input rate of the synthesizer.

8. The method of claim 1, wherein outputting the first portion of output speech by the synthesizer includes outputting hidden states corresponding to the plurality of phonemes, and further comprising, before providing the first portion of output speech to the second user device, transforming the hidden states corresponding to the plurality of phonemes into audio using a vocoder.

9. The method of claim 1, wherein the audio stream is associated with a voice chat function of a virtual experience.

10. The method of claim 1, further comprising training the synthesizer by:
training a first synthesizer using a synthesizer loss;
replacing the first synthesizer with a diffusion synthesizer; and
fine-tuning the diffusion synthesizer.

11. A trained machine-learning system comprising:
an encoder implemented by one or more processors, the encoder trained to perform operations comprising receiving an audio stream spoken in a first language and outputting encoded audio;
a phoneme decoder implemented by the one or more processors, the phoneme decoder trained to perform operations comprising receiving the encoded audio from the encoder and converting a first portion of the encoded audio into a plurality of phonemes of a second language;
a duration predictor implemented by the one or more processors, the duration predictor including a transformer encoder that is trained to perform operations comprising receiving the plurality of phonemes from the phoneme decoder and predicting a respective duration of respective phonemes in the plurality of phonemes; and
a synthesizer implemented by the one or more processors, the synthesizer trained to perform operations comprising outputting the first portion of output speech that includes the plurality of phonemes where each of the phonemes in the plurality of phonemes has the respective duration.

12. The system of claim 11, wherein the machine-learning system is trained by:
individually training the phoneme decoder using a decoder cross-entropy loss, the duration predictor using a per-phoneme L2 duration loss, and the synthesizer using a synthesizer loss; and
training the phoneme decoder, the duration predictor, and the synthesizer together using an overall loss.

13. The system of claim 12, wherein the overall loss is a weighted sum of the decoder loss, the duration loss, and the synthesizer loss.

14. The system of claim 12, wherein training the phoneme decoder, the duration predictor, and the synthesizer together includes training on speech to text translation tasks and speech to speech translation tasks.

15. The system of claim 12, wherein the encoder and the phoneme decoder are trained using synthetic training data that is generated by:
generating text in a style associated with a virtual experience from a chatbot;
translating the text to source audio in one or more different languages; and
using the text as ground truth data.

16. A non-transitory computer-readable medium with instructions stored thereon that, when executed by one or more computers, cause the one or more computers to perform operations, the operations comprising:
receiving an audio stream from a first user associated with a first client device, wherein the audio stream is spoken in a first language by the first user;
retrieving translation data associated with a second user, wherein the translation data includes at least a language preference associated with the second user, and wherein the second user is associated with a second user device;
converting a first portion of the audio stream received from the first user into a plurality of phonemes of a second language, wherein the second language is defined by the language preference;
predicting a respective duration of each of the phonemes in the plurality of phonemes;
outputting, by a synthesizer, a first portion of output speech that includes the plurality of phonemes where each of the phonemes in the plurality of phonemes has the respective duration; and
providing the first portion of output speech to the second user device;
wherein additional portions of the output speech are output based on subsequent portions of the audio stream.

17. The non-transitory computer-readable medium of claim 16, wherein the operations further include:
providing the first portion the audio stream as input to a tokenizer;
providing output from the tokenizer as input to an encoder; and
outputting, with the encoder, a vector representation of the audio stream, wherein the first portion of the audio stream that is converted is the vector representation of the audio stream.

18. The non-transitory computer-readable medium of claim 17, wherein converting the vector representation of the audio stream into the plurality of phonemes includes:
outputting, with a phoneme decoder, a first predicted phoneme of the plurality of phonemes;
generating a first query from the first predicted phoneme;
providing the first query, and a first key and a first value based on the vector representation of the audio stream to the phoneme decoder;
outputting, with the phoneme decoder, a subsequent predicted phoneme of the plurality of phonemes;
generating a subsequent query from the subsequent predicted phoneme;
providing the subsequent query, and a subsequent key and a subsequent value based on the vector representation of the audio stream to the phoneme decoder; and
continuing to predict phonemes with the phoneme decoder until a remaining vector representation of the audio stream is processed.

19. The non-transitory computer-readable medium of claim 17, wherein predicting a duration of each of the phonemes in the plurality of phonemes includes:
receiving, at an attention layer and from a phoneme decoder, a plurality of vectors that correspond to the plurality of phonemes;
converting, by the attention layer, the plurality of vectors into respective queries; and
generating, by the attention layer, output feature vectors based on the plurality of vectors that correspond to the plurality of phonemes and the vector representation of the audio stream.

20. The non-transitory computer-readable medium of claim 19, wherein the operations further include providing the output feature vectors to a variance predictor that predicts a variance of each phoneme of the plurality of phonemes.
